(19) United States
(12) Patent Application Publication
(10) Pub. No.: US 2026/0029306 A1
(43) Pub. Date: Jan. 29, 2026

(54) REAL-TIME CURRENT-BASED DISTRIBUTED BEARING FAULTS DETECTION IN SMALL COOLING FAN MOTORS

(71) Applicant: Board of Regents, The University of Texas System, Austin, TX (US)

(72) Inventors: Bilal Akin, Richardson, TX (US); Mojtaba Afshar, Dallas, TX (US); Chen Li, Richardson, TX (US)

(21) Appl. No.: 18/780,955

(22) Filed: Jul. 23, 2024

(51) Int. Cl. G01M 13/04; H02K 11/20

(52) U.S. Cl. CPC G01M 13/04; H02K 11/20

(57) ABSTRACT

Disclosed herein are techniques for detecting faults in motor bearings. The techniques can include obtaining operational data indicative of the motor's electromotive functionality and analyzing this data to extract performance metrics. Fault conditions can be determined by comparing these metrics with baseline values from normal motor operation. Alerts can be generated when deviations exceed predefined thresholds. The techniques can dynamically determine thresholds based on short-term and long-term statistical variances from baseline metrics, reflecting early-stage anomalies and advanced faults. Performance metrics can include root mean square (RMS) values, peak values, and crest factors. The techniques can support trend analysis to predict maintenance needs and can utilize lightweight algorithms for real-time monitoring on low-end controllers. Notifications of fault conditions can be transmitted to remote monitoring systems.

### STATEMENT OF GOVERNMENT SUPPORT

This invention was made with government support under Grant No. 2810.090 awarded by TxACE/SRC. The government has certain rights in the invention.

### FIELD

The present disclosure generally relates to monitoring technologies for electromechanical devices and, more particularly, to techniques for detecting bearing faults in cooling fan motors through current analysis.

### BACKGROUND

Cooling fan motors can play a role in various applications such as data centers, power converters, and industrial settings. One function can be to intake ambient cool air and expel heated air simultaneously. This thermal regulation process can be important in enhancing the durability and stability of the system as it mitigates the thermal degradation of electronic components, thereby improving system reliability. Cooling fans often operate continuously for extended periods. Failures in their assembly or maintenance can lead to operational anomalies such as vibration and acoustic disturbances. These disturbances can impede the cooling fan's effectiveness in efficiently dispersing heat, leading to an escalation in the environmental thermal burden. This heightened thermal can negatively impact the functionality or overall performance of the electronic components either by deteriorating their quality or compromising their operational capabilities.

Failure root cause analyses have demonstrated that bearing faults can be a significant cause of failure in cooling fan applications. A ball bearing can include several components, including raceways, ball elements, and a cage. Improper maintenance practices such as inadequate lubrication, contamination, the presence of dust or moisture in the lubricant, or incorrect installation can contribute to bearing failures. Bearing faults manifest as defects in the raceways within the bearing, and may lead to issues such as circumferential peeling or spalling on inner and/or outer raceways.

### SUMMARY

Certain illustrative examples are described in the following numbered clauses:

Clause 1. A method for dynamically detecting faults in motor bearings, the method comprising:
obtaining operational data corresponding to the operation of a motor, wherein the operational data comprises an electrical parameter indicative of an electromotive functionality of the motor;
retrieving a baseline performance metric from a database, wherein the baseline performance metric is derived from historical data corresponding to normal, healthy operation of the motor, the baseline performance metric including a motor current signal;
continuously monitoring the operational data to obtain real-time performance metrics, including a real-time root mean square (RMS) value, a real-time peak value, and a real-time crest factor of the electrical parameter;
performing a trend analysis on the real-time performance metrics to identify deviations from the baseline performance metric;
dynamically determining a first threshold by calculating a short-term statistical variance from the baseline performance metric, wherein the first threshold represents a range of acceptable performance variation, and deviations beyond this range suggest early signs of anomalies in the motor bearings;
dynamically determining a second threshold by calculating a long-term cumulative deviation from the baseline performance metric, wherein the second threshold represents a significant and sustained deviation from normal performance, suggesting anomalies in the motor bearings;
detecting a fault condition in the motor bearings when the real-time performance metrics exceed either the dynamically determined first threshold, indicating early signs of anomalies, or the second threshold, indicating significant anomalies; and outputting an indication of the fault condition.

Clause 2. The method of Clause 1, wherein the historical data comprises data corresponding to the operation of the motor during a first period of time.

Clause 3. A method for detecting faults in motor bearings, the method comprising:
obtaining operational data corresponding to the operation of a motor, wherein the operational data comprises an electrical parameter indicative of an electromotive functionality of the motor;
analyzing the operational data to extract performance metrics;
determining a fault condition based on the analysis of the operational data; and
outputting an indication of the fault condition.

Clause 4. The method of Clause 3, further comprising:
dynamically determining a first threshold by calculating short-term statistical variances from a baseline performance metric, where the baseline performance metric is derived from historical data of normal motor operation and the short-term statistical variances are calculated using differences between recent performance metric values and the baseline, wherein the first threshold represents a range of acceptable performance variation, and deviations beyond this range suggest early signs of anomalies in the motor bearings; and
comparing the performance metrics with the first threshold,
wherein the determining a fault condition is based on a determination that the performance metrics deviate from the baseline performance metric by an amount that satisfies the first threshold.

Clause 5. The method of clause 4, wherein the first threshold corresponds to deviations of 1% to 4% from the baseline performance metric.

Clause 6. The method of Clause 3, further comprising:
dynamically determining a second threshold by calculating long-term statistical variances from a baseline performance metric, where the long-term statistical variances are calculated using differences between a long-term trend of performance metric values and the baseline performance metric, wherein the second threshold represents a significant and sustained deviation from normal performance, suggesting anomalies in the motor bearings;
comparing the performance metrics with the second threshold; and
wherein the determining a fault condition is based on a determination that the performance metrics deviate from the baseline performance metric by an amount that satisfies the second threshold.

Clause 7. The method of clause 6, wherein the second threshold corresponds to deviations of 3% to 10% from the baseline performance metric.

Clause 8. The method of clause 6, further comprising:
comparing the extracted performance metrics to a threshold, wherein the threshold comprises at least one of:
a first threshold indicative of early signs of anomalies, wherein deviations from normal operating conditions that meet or exceed this threshold suggest potential early-stage bearing issues; or
a second threshold indicative of significant deviations from normal operating conditions, wherein deviations that meet or exceed this threshold suggest advanced bearing faults, wherein the determining the fault condition is based on the comparing.

Clause 9. The method of Clause 3, wherein the performance metrics comprise at least two of a root mean square (RMS) value, a peak value, or a crest factor of the electrical parameter.

Clause 10. The method of Clause 3, further comprising comparing the extracted performance metrics to predetermined thresholds, wherein the predetermined thresholds are based on historical data correlated with known bearing faults under varying operational conditions, wherein determining the fault condition comprises identifying at least one instance where a performance metric satisfies a predetermined threshold.

Clause 11. The method of Clause 3, wherein the electrical parameter comprises at least one of an electric current flowing through windings of the motor, a voltage measured across terminals of the motor, or a power consumption by the motor.

Clause 12. The method of Clause 3, further comprising:
1. performing trend analysis on the operational data and extracted performance metrics to identify changes in motor bearing conditions over time, wherein the trend analysis comprises statistical analysis of the data to detect patterns indicative of bearing wear or degradation; and
2. outputting an indication of a maintenance action, wherein the indication is indicative of at least one of a predictive maintenance schedule or a recommendation for motor bearing replacement or repair.

Clause 13. The method of Clause 3, wherein determining the fault condition comprises recognizing patterns in the performance metrics indicative of a bearing fault, wherein the patterns reflect characteristic anomalies associated with bearing faults identified from historical operational data.

Clause 14. The method of Clause 3, wherein outputting the indication of the fault condition comprises at least one of:
generating an alarm signal indicating a presence of the fault condition in the motor bearings;
logging an alarm event with a timestamp, the associated performance metrics, and the fault condition in a database for historical tracking and/or analysis; or
transmitting a notification to a remote monitoring system, the notification comprising details of the fault condition, the associated performance metrics, and the timestamp.

Clause 15. The method of Clause 3, wherein the performance metrics comprise a root mean square (RMS) value and/or a peak value, wherein changes in the RMS value and/or the peak value are indicative of at least one of increased friction or reduced lubrication effectiveness, and wherein the bearing fault is defined as a condition characterized by improper lubrication.

Clause 16. The method of Clause 3, wherein the performance metrics comprise a crest factor, wherein fluctuations in the crest factor reflect intermittent obstruction or irregularities in the bearing surfaces, and wherein the bearing fault is defined as a condition characterized by contamination with debris.

Clause 17. The method of Clause 3, wherein the performance metrics comprise noise in the electrical parameter, wherein increased noise in the electrical parameter is indicative of surface degradation or roughness, and wherein the bearing fault is defined as a condition characterized by wear of the bearing surfaces.

Clause 18. The method of Clause 3, wherein the performance metrics comprise at least one of a root mean square (RMS) value, a peak value, or a crest factor, wherein variations in the at least two of the RMS value, the peak value, or the crest factor indicate a loss of proper bearing alignment or spacing, and wherein the bearing fault is defined as a condition characterized by increased clearance within the bearing.

Clause 19. The method of Clause 3, further comprising applying a trained machine learning algorithm to the extracted performance metrics to classify the fault condition.

Clause 20. A method for real-time detection of bearing faults in small cooling fan motors, comprising:
monitoring a current signal of a motor to collect operational data;
analyzing the operational data to compute time-domain statistical features, the time-domain statistical features comprises root mean square (RMS) values, peak values, and crest factors;
comparing the time-domain statistical features against baseline values established from healthy motor operation;
identifying deviations in the time-domain statistical features that indicate a presence of a bearing fault; and
generating an alert when the deviations exceed predefined threshold levels, the alert corresponding to an indication of bearing faults.

### BRIEF DESCRIPTION OF THE DRAWINGS

Throughout the drawings, reference numbers can be re-used to indicate correspondence between referenced elements. The drawings are provided to illustrate embodiments of the present disclosure and do not limit the scope thereof.

FIG. 1 illustrates an example effect of lubrication viscosity on the Root Mean Square (RMS) values of motor current.

FIG. 2 illustrates an example bearing clearance before and after aging.

FIG. 3 illustrates an example relationship between bearing frictional moment, lifespan, load zone, and bearing clearance.

FIG. 4 illustrates an example impact of motor size on the RMS value of motor current due to lubrication issues.

FIG. 5 illustrates example laboratory test setups and configurations used herein.

FIG. 6 illustrates an example setup used for accelerated bearing aging.

FIGS. 7A-7C illustrate examples of bearings after undergoing the aging process.

FIG. 8 illustrates example trends of features such as RMS, peak amplitude, and crest factor in aging fan motors.

FIGS. 9A-9F depict the impact of bearing faults on stator current, showcasing variations in RMS values, peak values, and crest factors across different operational conditions.

FIG. 10 illustrates an example routine for detecting distributed bearing faults.

FIGS. 11A and 11B illustrate example test results for motors, indicating raised flags and alarm triggers.

FIG. 12 illustrates example performance under different sensitivity settings of α and β.

FIG. 13 illustrates an example implementation of false detections in healthy motors.

FIG. 14 illustrates an example confusion matrix for binary classification.

FIGS. 15A and 15B illustrates an example evaluation of classification metrics at various α and β sensitivity levels and operational speeds.

FIG. 16 illustrates an example confusion matrix for a training dataset of the machine learning model, in accordance with some aspects of the inventive concepts.

FIG. 17 illustrates an example confusion matrix for a test dataset of the machine learning model, in accordance with some aspects of the inventive concepts.

FIG. 18 illustrates an example comparison of classification metrics between an example routine, as disclosed herein, and the machine learning model.

### DETAILED DESCRIPTION

Monitoring the health and performance of small cooling fan motors can be important for maintaining the reliability and efficiency of various electromechanical systems. Traditional methods of fault detection, such as vibration and acoustic analysis, often face limitations due to the high cost of sensors, complex installation, and ongoing maintenance requirements. These challenges highlight the need for more practical and cost-effective techniques for monitoring motor health, particularly in environments where small motors play a role.

Some inventive concepts described herein improve the process of detecting bearing faults in small cooling fan motors by utilizing current analysis. Unlike traditional methods, current analysis can offer an economical and easily integrable approach to monitoring motor health. By analyzing operational data corresponding to the electrical parameters of the motor, such as root mean square (RMS) values, peak values, and crest factors, the disclosed systems can detect anomalies indicative of bearing faults, sometimes without the need for additional sensors.

Some inventive concepts described herein provide mechanisms for real-time fault detection and alert generation. These systems can monitor the motor's current signals and identify patterns that suggest bearing degradation. When a fault condition is determined based on the analysis of the operational data, the system can generate alerts, such as visual or auditory signals, to notify maintenance personnel. This proactive approach can enable timely intervention, reducing the risk of motor failure and enhancing the overall reliability of the system.

Some inventive concepts described herein relate to a fault detection system designed to operate within low-bandwidth environments, making it suitable for small motors with limited processing capabilities. The system can capture current signals under various operational conditions, including healthy and faulty states, and analyze them using lightweight algorithms. By processing these signals on microcontrollers, the system can provide accurate fault detection without the need for high computational resources. This ensures that the monitoring solution is both efficient and practical for widespread deployment.

Some inventive concepts described herein relate to improving the sensitivity and accuracy of fault detection routines. For example, by adjusting parameters such as sensitivity gain and threshold levels, the system can balance the trade-off between detecting faults early and reducing false alarms. This customization allows for tailored monitoring solutions that can adapt to different operational environments and motor specifications, thereby improving the overall effectiveness of the fault detection process.

Some inventive concepts described herein represent a notable advancement in the field of motor health monitoring, particularly in enhancing the accuracy and efficiency of bearing fault detection in small cooling fan motors. By leveraging current analysis and advanced signal processing techniques, these inventive concepts provide a robust and cost-effective solution for ensuring motor reliability. The disclosed techniques allow for the detection and reporting of bearing faults, conserving energy and computational resources while delivering reliable monitoring, thus improving the practical application of these technologies in various industrial and commercial settings.

As used herein, the term “small motor,” can refer to a specific class of electric motors characterized by at least one of a power capacity, a size, or an intended use. For instance, a small motor may have a maximum power output not exceeding 750 Watts, or it may operate at nominal voltages up to 240 Volts. Alternatively, a small motor may be defined as any motor used in cooling fan mechanisms within electronic devices, including, but not limited to, computers, power converters, and heating, ventilation, and air conditioning (HVAC) systems in both commercial and residential settings.

### INTRODUCTION

Several techniques, including vibration analysis, acoustic analysis, and motor current analysis, have been developed to assess bearing conditions and detect faults. However, while vibration and acoustic signals have proven to be effective methods for detecting bearing faults, their adoption is hindered by factors like high sensor costs, intricate installation requirements, and ongoing maintenance expenses. As a result, the application of these techniques may become unfeasible, particularly in the case of small motors. On the other hand, current analysis emerges as an economical alternative that exhibits the capability to identify faults in electrical machines. Its affordability and seamless integration make it a favored selection.

The detection of bearing faults through current analysis poses distinct challenges in larger motors, as fault signatures can be concealed within current signals. This complexity can demand the utilization of advanced signal processing techniques, encompassing noise cancellation filters, frequency and time-frequency domain signal processing methods, and/or artificial intelligence methodologies like machine learning and deep learning. In contrast, employing current analysis in smaller fan motors may prove more effective due to their reduced torque and inertia, leading to clearer discernment of bearing fault impacts on the current signal.

In the context of larger motors, various methodologies have been proposed to discern bearing fault-related components from dominant elements. Through the utilization of noise cancellation strategies and statistical control techniques, the extraction of distinct patterns linked to bearing faults from the stator current may be achievable, thereby enabling the identification of distributed bearing faults. Both statistical and frequency domain approaches can be harnessed to derive relevant features for fault detection. Within the motor current spectral analysis, the variance in amplitude among frequency constituents can emerge as a characteristic that can be important for the training of machine learning models to discriminate between normal and faulty states.

A cascading Neural Network (NN) classifier can be implemented for bearing fault detection. This classifier harnesses time-domain analysis of stator current to derive pertinent features, which can be subsequently input into the cascade NN, thereby facilitating effective fault detection. The simultaneous identification of multiple motor faults can be accomplished by integrating motor current and vibration signals. Transforming the signals into time-frequency distributions via wavelet transform, they can be then treated as grayscale images. Subsequently, a two-dimensional convolutional neural network can be deployed to achieve accurate detection of bearing faults.

Approaches can leverage multivariate Gaussian distribution and correlation coefficients to detect anomalies in fan speed, consequently enabling the anticipation of fan failures. A probabilistic model can predict server fan failures. Additionally, a model can be for fan life expectancy, grounded in the Weibull distribution, mean time to failure, and diverse testing methodologies. Considerable investigation has been conducted within the domain of identifying bearing faults in large motors through the application of advanced signal processing techniques in current analysis. Nonetheless, a continuous requirement persists for the creation of straightforward, practical, and dependable fault detection routines tailored to small fan motors, obviating the necessity for intricate signal processing methodologies.

Described herein are systems and methodologies for the detection of distributed bearing faults in small fan motors. The systems and methodologies can be implemented on microcontrollers within fan applications with limited processing capabilities and low bandwidth. Small fan motors can be characterized by their low torque and inertia, which renders the impact of bearing faults on motor current pronounced, leading to detectable fault indicators within the current signals. To achieve this objective, a series of systems (sometimes referred to as setups) can be established. These setups can facilitate the collection of operational data (e.g., motor current data) under various operational conditions including, but not limited to, healthy conditions, lubrication-related issues, or contamination issues. The motors can be operated with their original, healthy bearings across a range of speeds (e.g., from 10% to 100% of the nominal speed), incrementing in predefined (e.g., 10%) intervals, while subjected to free run and/or fan load scenarios. To accelerate bearing deterioration, the lubricant can be gradually cleaned by dissolver, thereby simulating lubrication-related faults. Moreover, contamination-induced issues can be emulated by introducing fine rock tumbler grit to the bearing. The motors can be operated until failure. At different stages of this aging process, current signals were recorded under different speed levels and load conditions, and these data were systematically archived for subsequent analysis.

The collected operational data undergoes analysis, wherein time-domain statistical or (sometimes referred to as a performance index) like root mean square (RMS), peak values, and crest factors can be utilized. These statistical attributes facilitate the recognition of patterns linked to distributed bearing faults. Drawing upon the extracted characteristics and/or the trend analysis, a system and/or methodology (e.g., an algorithm) can be used to detect distributed bearing faults for low-bandwidth microcontrollers. Disclosed herein, example methodology is evaluated for sensitivity analysis and false detection assessment. Furthermore, an example machine learning classifier employing the random forest technique is developed. A comparison between this classifier and the methodology is conducted herein to assess their individual performances and potential applicability within edge computing scenarios.

Bearing Faults and their Impact on Stator Current

The presence of bearing faults can give rise to mechanical shockwaves characterized by spontaneous high-frequency torque oscillations. These shockwaves may be provoked when a faulty component makes contact with another section of the bearing, thereby introducing an additional random torque associated with the bearing fault into the motor load. The total load torque, T_{L}(t), can be represented as:

$${T}_{L} ( t ) = K \times {ω}^{2} + N ( T ) + {T}_{B} ( t ) \qquad ( Equation 1 )$$

where the symbol K represents the fan blade coefficient, ω denotes the rotational speed, N(t) signifies the Gaussian random component, and T_{B}(t) represents the random load torque due to a bearing fault. Initially, these random components exert an impact on the generated load torque, inducing unpredictable vibrations within a cooling fan system and leading to fluctuations in the motor's air gap. Subsequent alterations in the air gap, in turn, exert a direct influence on the magnetic field of the air gap. Consequently, random components manifest within the stator current.

### Factors Influencing Friction in Bearing in Small Motors

Bearing faults lead to the deterioration of the bearing surface, causing alterations in friction within the affected bearing. When it comes to machine bearings, factors that may affect friction in small motors can include lubrication or the amount of clearance.

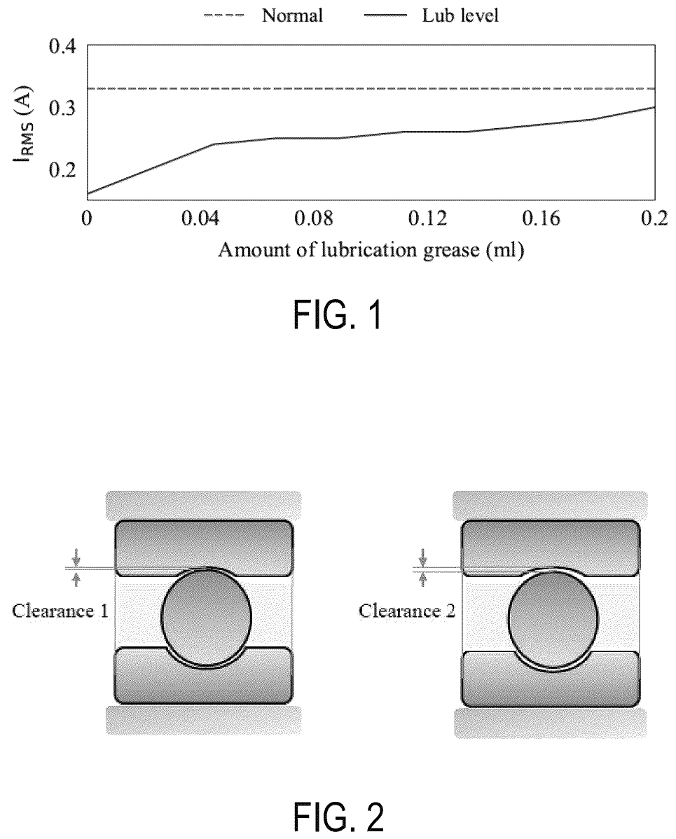

1) Bearing Lubrication: The lubrication within a bearing can serve multiple functions: in some cases, it reduces viscosity drag and safeguards bearing surfaces against damage arising from debris and contaminants, along with corrosion prevention. This lubricant facilitates oil delivery for effective lubrication and heat transfer within the bearing. In contrast to large motors, the lubrication amount can have a notable impact on viscosity drag within small motors. This significance of lubrication amount's influence on viscosity drag in small motors is demonstrated in FIG. 1. For example, FIG. 1 illustrates an example effect of lubrication viscosity on the Root Mean Square (RMS) values of motor current. Initial-stage low lubrication yields reduced viscosity drag and RMS values of the current, whereas an elevated lubricant quantity increases viscosity drag. Subsequent to a bearing fault, alterations in lubricant viscosity might occur due to thermal decomposition, debris, or other contaminants. Additionally, insufficient lubrication can prompt escalating temperatures, and metallic contact during motion results in the fusion of asperities on surfaces, subsequently disentangled by the relative movement, leading to adhesion and abrasion. Furthermore, the viscosity drag arising from asperity contact can lead to abrupt spikes in motor torque.

2) Bearing Clearance: FIG. 2 illustrates an example bearing clearance before and after aging. Illustrated in FIG. 2, the standard bearing clearance, denoting the separation between the two rings that allow relative motion, experiences alterations before and after aging. In small bearings, in the absence of lubrication, the clearance progressively widens over time due to the detachment of debris particles from the bearing race, thereby amplifying the bearing clearance and simultaneously reducing friction. This evolution may be imperceptible in larger bearings, attributed to their enhanced bearing hardness. Moreover, the extent of bearing clearance is shaped by a spectrum of variables: temperature, inner and outer race dimensions, and shaft size. Additionally, heightened temperatures amplify the likelihood of escalated friction, consequently elevating the potential for interlocking irregularities on surfaces. This phenomenon can impede the seamless motion of bearing balls. Thus, the careful determination of an optimal clearance value can be important.

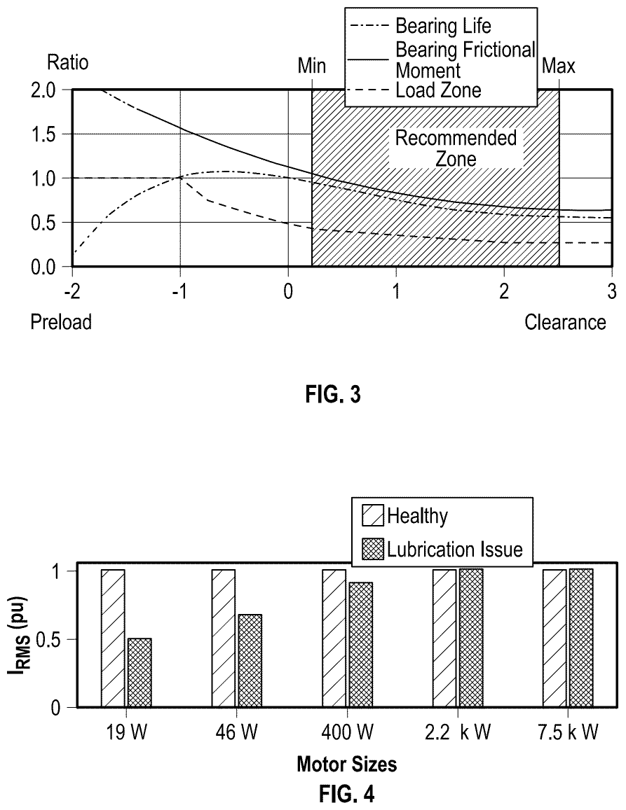

FIG. 3 illustrates an example relationship between bearing frictional moment, lifespan, load zone, and bearing clearance. The chart indicates that when the bearing clearance increases, both friction within the bearing and load zone decrease. Nevertheless, a rise in clearance can lead to increased vibration, resulting in more extensive corrosion and impact, ultimately causing a reduction in the bearing's lifespan. It can be noted that insufficient lubrication may initially contribute to viscosity reduction, resulting in diminished friction. Nonetheless, prolonged operation raises temperature levels, inducing gradual wear and potential expansion of component clearances, thereby causing a subsequent friction decrease. However, this heightened contact elevates the risk of surface detachment, introducing particles into the bearing. Consequently, the probability of interlocking between bearing components rises, subsequently amplifying friction.

### Example Impact of Motor Size on Stator Current

Larger motors may inherently generate elevated torque, resulting in amplified current levels. Consequently, the endeavor of detecting fault indicators within motor current can include the employment of advanced signal processing techniques. Conversely, in smaller motors, characterized by diminished torque and inertia, the manifestation of mechanical anomalies through current signals is apparent. FIG. 4 illustrates an example impact of motor size on the RMS value of motor current due to lubrication issues. Illustrated in FIG. 4, smaller motors demonstrate a minor early-stage reduction in motor current value, attributed to decreased friction originating from reduced lubrication viscosity, followed by an elevation in clearance. Conversely, this phenomenon may hold less significance in large motors, as their elevated bearing hardness ensures a consistent bearing clearance and the production of elevated torque. This characteristic in smaller motors presents the potential for employing straightforward statistical time domain attributes for monitoring their operational health.

### Example Methodology

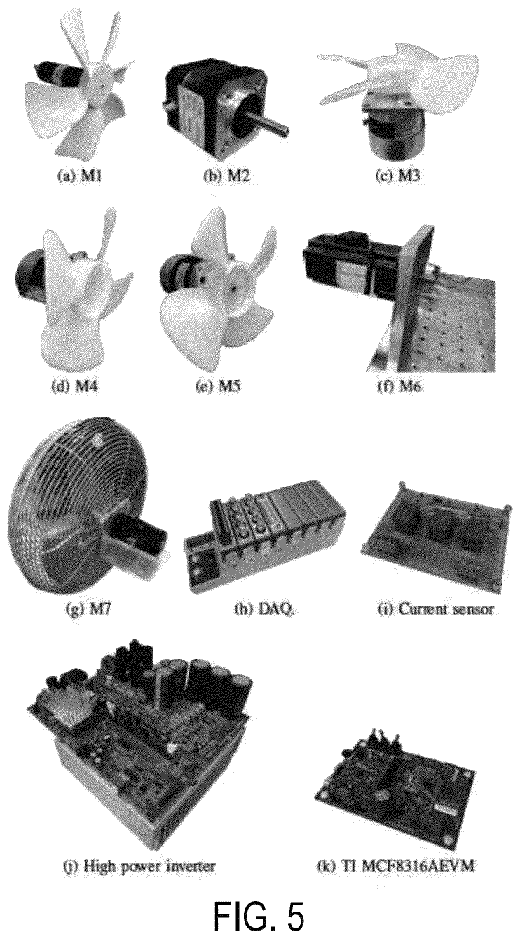

Techniques disclosed herein allow for the identification of distributed bearing faults in small cooling fan motors by employing diverse test setups. In total, seven distinct setups were utilized, encompassing PMSM motors with a power rating of 400 W, as well as BLDC motors with power ratings of 92 W, 46 W, 26 W, and 19 W. Detailed information regarding the motor specifications employed in this study can be referenced in Table 1. FIG. 5 provides an overview of the test setups employed, showcasing the motors, the controllers, current sensors, and data acquisition equipment involved. The PMSM motors can be controlled using the TI C2000 microprocessor, and BLDCs can be controlled using TI MCF8316A, which is a low-cost, low-end controller. Through, motors can be controlled by field-oriented control techniques. To measure the phase currents, LEM current sensors HX 10-P can be employed. The currents can be captured using the NI cDAQ-9178 data acquisition system at a sampling frequency of 10 kHz. The measurements can be conducted over a duration of 10 seconds, encompassing 10 different speed levels ranging from 10% to 100% of the nominal speed, with a 10% increment. Additionally, both healthy and faulty operating conditions can be investigated for motors operating under both fan load and no-load conditions.

TABLE 1
The Motors Specifications Employed In This Research.

| Motor Voltage | Power | Bearing | Load Mount |
|---|---|---|---|
| M1 24 | 19 | 3700 L940ZZ | Fan Horizontal |
| M2 24 | 26 | 4000 R-1650HH | Free/Horizontal |
| M3 24 | 46 | 4000 608ZZ | Fan/Horizontal |
| M4 24 | 46 | 4000 608ZZ | Fan/Vertical |
| M5 24 | 92 | 4000 608ZZ | Fan/Vertical |
| M6 200 | 400 | 3000 6003ZZ | Free/Vertical |
| M7 200 | 400 | 3000 6003ZZ | Fan/Vertical |

### Aging Acceleration

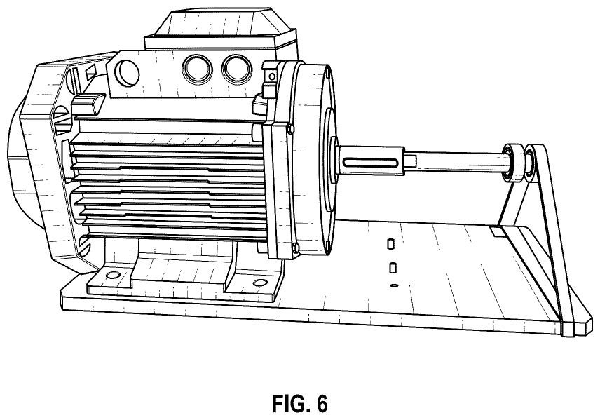

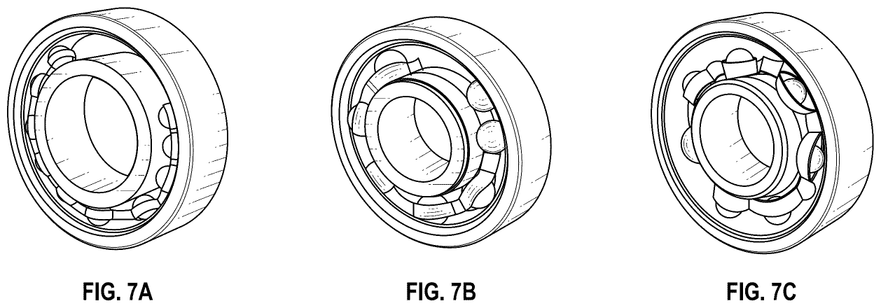

Described herein are techniques to expedite the aging process: accelerated aging and time-based aging. Accelerated aging involves employing the setup illustrated in FIG. 6 to accelerate the deterioration of bearings. FIG. 6 illustrates an example setup used for accelerated bearing aging. This arrangement can include directly connecting an induction motor to the grid with an extended shaft. The bearings to be aged can be positioned on the extended shaft, and to expedite the aging process, the outer race is securely fastened with tape, while the induction motor operates at a speed of 1750 rpm. The presence of an extended shaft can contribute to increased vibration, thereby accelerating the aging process. The motor's bearings undergo aging at specific intervals and can be subsequently reinserted into the motor to collect current data under different speed levels and load conditions. The time-based aging process can include the elimination of bearing lubricants using a lubricant dissolver. Subsequently, the bearings can be reinserted into the motor shaft and operated until they eventually fail. Data is gathered at various intervals, starting from the initial stage after lubricant removal, continuing until the bearings reach their end-of-life stage. FIGS. 7A-7C illustrate examples of bearings after undergoing the aging process.

### Feature Extraction

Given the inherent constraints of microprocessors, characterized by, for example, limited memory capacity and computational processing power, the development of a computationally lightweight algorithm for diagnosing distributed bearing faults in small fan motors remains an ongoing endeavor. To effectively address this challenge, an evaluation of various time domain statistical attributes is undertaken, leading to the introduction of simple and practical time domain features. These features can be subsequently deployed on data acquired from both healthy and faulty motors. A scrutiny of the extracted features, encompassing an examination of their discernible patterns and inherent attributes, can be conducted to identify bearing faults.

### Statistics for Bearing Fault Identification

Changes in the friction of bearing surfaces arise from factors such as bearing roughness and wear resulting from lubrication and contamination problems. To effectively quantify these fluctuations in friction, the Root Mean Square (RMS) value of the phase current can be computed, as formulated in Equation (2). This recommendation is grounded in the fact that the RMS value encompasses significant details about the mean friction experienced by the bearing. By taking the average of squared sampled currents, the RMS value accurately depicts the underlying trend of variation in friction.

$${I}_{R M S} = \sqrt{\frac{1}{n} {\sum }_{i = 1}^{n} {i}_{sampled}^{2}} \qquad ( Equation 2 )$$

where the variable I_{RMS} represents the root mean square of the sampled current, while i_{sampled} denotes the actual sampled current.

The emergence of a distributed bearing fault results in a substantial increase in the roughness of the bearing raceway, leading to the formation of numerous asperities on the bearing surfaces. Consequently, there is an increased likelihood of these rough surfaces interlocking, resulting in a higher occurrence of torque pulses in the motor. The stator current also exhibits this behavior, with a noticeable rise in pulse frequency. To accurately capture this phenomenon, the peak and crest factor can be used. These terms refer to the peak amplitude and the ratio between the maximum amplitude and the RMS value, respectively. The crest factor measurement provides valuable information about the extent of deviation from the average value, which can be used for identifying and studying current pulse fluctuations.

$${I}_{Peak} = max ( {i}_{sampled} ) \qquad ( Equation 3 )$$

$${I}_{Crest} = \frac{{I}_{Peak}}{{I}_{R M S}} \qquad ( Equation 4 )$$

where the variable Iₚₑₐₖ represents the maximum value of the sampled current and I_{Crest} refers to the crest factor.

### C. Analysis of Extracted Features

To establish the reliability of the selected features, including RMS value, peak value, and crest factor, for accurate detection of distributed bearing faults, an evaluation is performed under diverse aging durations and varying operational conditions. The assessments can be examined from multiple angles to attain a more holistic understanding of how lubrication and bearing clearance affect friction within the bearing. The test outcomes yield a significant understanding of the influence of lubrication and bearing clearance on bearing friction.

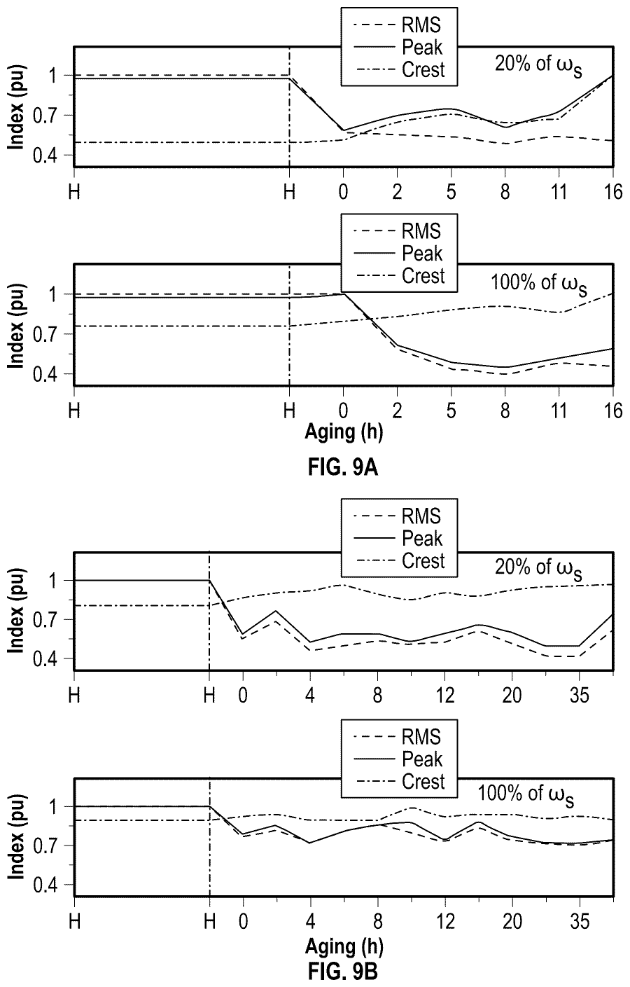

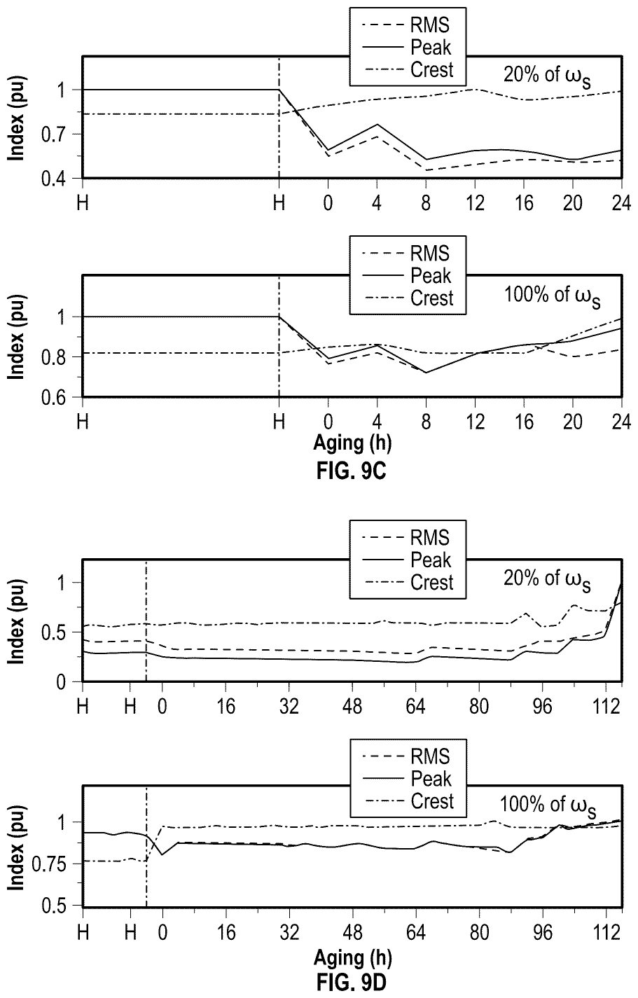

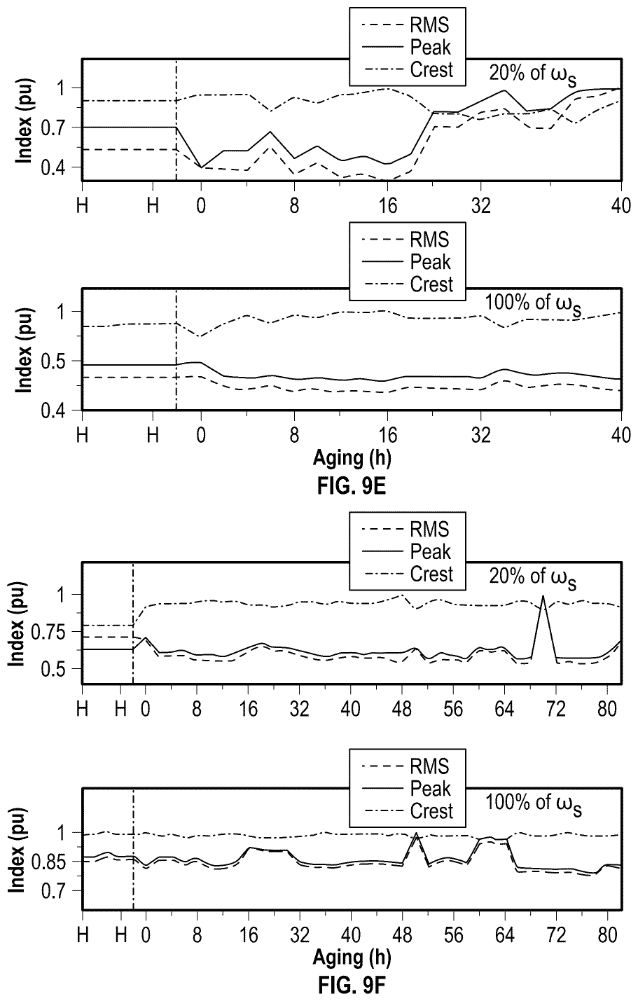

FIGS. 9A-9f depict the impact of bearing faults on stator current, showcasing variations in RMS values, peak values, and crest factors across different operational conditions. To achieve an understanding of the performance of fan motors under varying aging durations and speeds, graphical representations are presented in FIGS. 9A-9f, elucidating recommended features such as RMS, peak values, and crest factors. These graphical representations document the operational duration of the motors, encompassing both their healthy state and their progressive aging over time. Within the figures, the designation H signifies healthy condition, and the reference point of 0 hours denotes the moment at which lubrication was removed, with no aging effects evident at that juncture. The removal of lubrication results in a decline in lubricant viscosity, in conjunction with an augmentation in bearing clearance. This sequence of events contributes to a gradual reduction in the RMS value. With the accumulation of aging hours, the temperature of the bearing rises, resulting in the expansion of bearing components and heightened friction between them. Consequently, there is an elevation in the RMS value. Concurrently, during this phase, both peak and crest values exhibit a gradual and continuous increase. In the final stages of aging, surface asperities become more pronounced, leading to separation and preventing the smooth traversal of these surface variations without becoming interlocked. Consequently, there is a surge in motor current, resulting in random spikes that drive an escalation in various parameters: RMS, peak values, and crest factors. Generally, it can be observed that the RMS value decreases after lacking lubrication due to reduced viscosity drag and then increases when it reaches its final stage.

Moreover, as the aging hours accumulate, there may be an increase within the crest factor value, accompanied by considerable random variation. The influence of speed on the feature is such that the centrifugal force contributes to smoother characteristics. The correlation between the measured crest factor and the peak value is also demonstrated that when the motor is in a healthy state, the lubrication film separates the asperities on the inner and outer races, thereby preventing significant torque pulses. In contrast, if the lubrication is insufficient or absent, the bearing asperities within the bearings can experience intermittent lock together, causing larger torque fluctuations compared to when the bearings are in a healthy state. As a consequence, both the crest factor and peak value of the current increase. Moreover, there may be a decrease in the crest factor when the motor speed increases, which reduces the chances of asperities seizing. As the bearing nears the end of its operational life, the rate at which the crest factor value changes becomes more noticeable due to increased friction and the presence of asperities. Additionally, by examining the combined changes in all three suggested characteristics, distributed bearing faults can be detected in fan motors.

### Fault Diagnosis

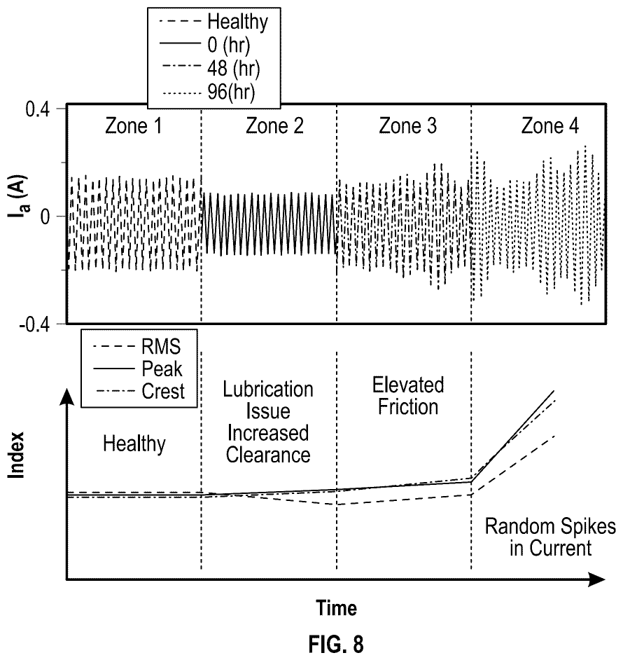

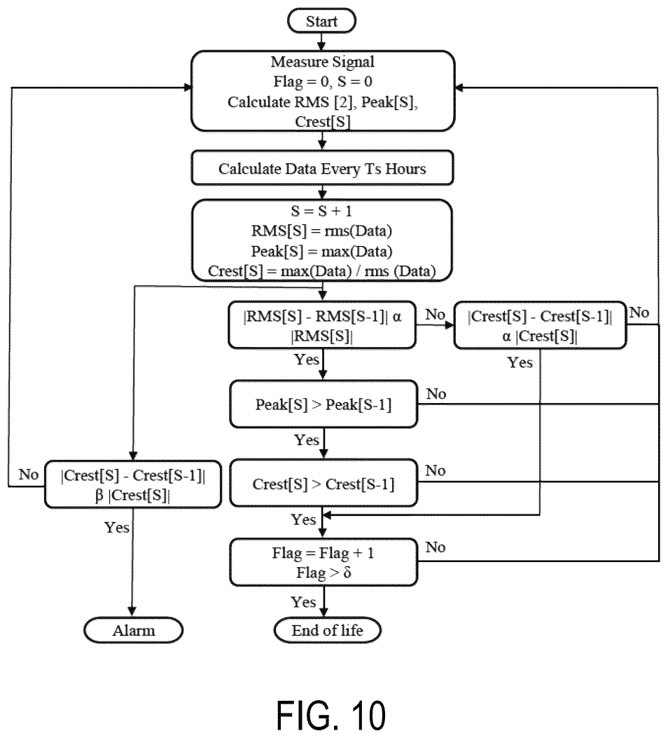

FIG. 8 illustrates example trends of features such as RMS, peak amplitude, and crest factor in aging fan motors. Based on the identified trends presented in FIG. 8 pertaining to distributed bearing faults in fan motors, a routine (FIG. 10) has been developed. The disclosed techniques incorporate various parameters: S representing the state, number of collected data samples; Flag, an indicator for warnings; Ts, the sampling algorithm; δ, the threshold count; α, the sensitivity gain for warnings; and β, the sensitivity gain for alarms. The collection of data samples can be carried out under specific operating conditions, such as a predefined speed and load. The value of Ts can be determined based on the condition of the bearings, potentially being reduced in the presence of raised flags. The range of a can be defined between 1% to 4%, while the range of β can be between 3% to 10%. The selection of the threshold value δ can be determined based on the significance of the application and the desired levels of sensitivity gain. The disclosed techniques utilize the current signal and calculate time domain features such as RMS value, peak value, and crest factor to determine the condition of the bearing. The disclosed techniques detects distributed bearing faults in fan motors by comparing the current state of the features with their previous state. Initially, during the first execution of the disclosed techniques, the features are calculated based on a healthy reference. Subsequently, at intervals of Ts hours, new measurements are taken, and the features are recalculated. The resulting feature arrays can be compared, yielding outputs, such as an alarm condition and an end-of-lifetime indication. The alarm condition can be triggered by detecting significant changes in the crest factor, which may occur due to ball obstruction or external forces such as contact with the fan. Conversely, the end-of-lifetime output is designed to identify bearing surface roughening and wear. This output can use the features to raise a flag, and if the number of flags exceeds the threshold value, the end-of-lifetime indication is generated.

### Example Results

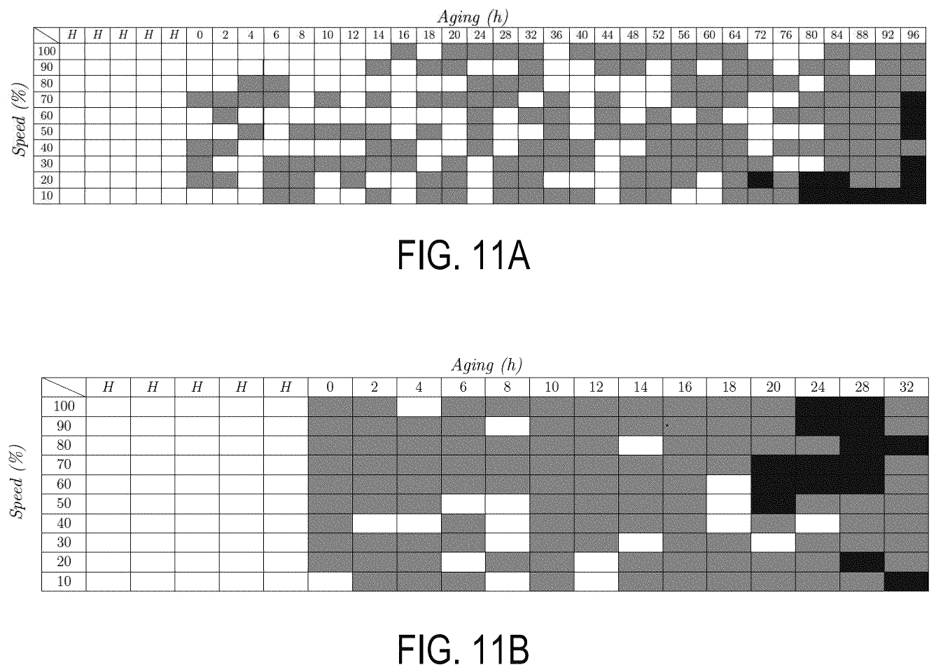

Some inventive concepts described herein utilize the collected data from motors M4 and M6 in a sequential manner. The data includes current measurements taken from various conditions, such as five healthy samples and one sample for each aging hour from 0 to the end of the motor's lifespan. The results are presented for different speeds ranging from 10% to 100% of the nominal speed. FIGS. 11A and 11B illustrate example test results for motors, indicating raised flags and alarm triggers. In FIGS. 11A and 11B, a light gray pattern indicates a raising flag for the tested sample, while dark gray slots represent alarm outputs. In this instance, the α gain is set to 1%, and the β gain is set to 10%. As shown, the disclosed techniques can detect early stages of bearing issues related to lubrication issues. Additionally, the alarms are triggered during the later stages due to a significant variation in the crest factor caused by the presence of asperities at the end of the bearing's lifespan.

### Sensitivity Check

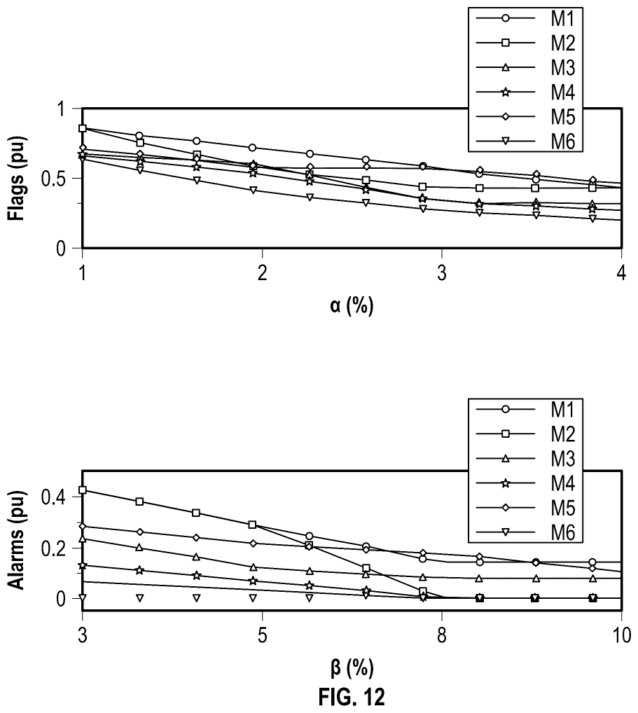

Some inventive concepts described herein allow for detecting distributed bearing faults, which can effectively control sensitivity by adjusting the parameters α and β. The performance of the disclosed routine is evaluated for various sensitivity levels, with a ranging from 1% to 4%, and β ranging from 3% to 10%. FIG. 12 illustrates example performance under different sensitivity settings of α and β. To ensure fair comparison among different motors, the raised flags and alarms may be adjusted in proportion to the total number of test samples for each motor. This normalization accounts for the varying amount of data collected. Consequently, lower sensitivity levels yield greater detection rates, enhancing the routine's sensitivity to bearing faults.

### False Detection Analysis

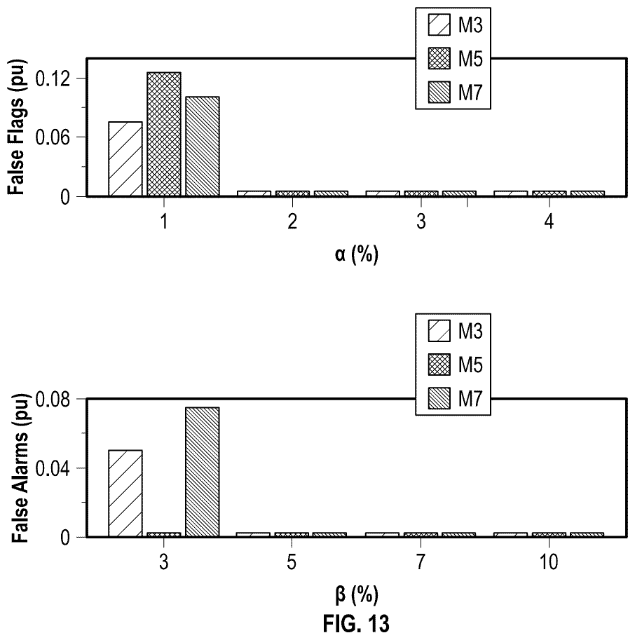

In order to ensure the reliability of the disclosed techniques and avoid false detections, a series of tests were conducted on motors M3, M5, and M7 while they were in a healthy state. For each motor, a total of 40 samples were collected at 10 speeds, resulting in a cumulative count of 400 healthy samples for each motor. FIG. 13 illustrates an example implementation of false detections in healthy motors. The normalized occurrences of raised flags and alarms for each motor are depicted in FIG. 13. The results indicate that on average, the algorithm with a threshold value of α=1% produces approximately 10% false flags. Thus, it is advisable to increase the threshold value to α=2% to minimize false detections. Furthermore, the sensitivity of the alarm, represented by β, plays a role in detecting significant changes in the crest factor. This, a relatively higher value of β, such as 10%, may effectively reduce false alarms.

### D. α, β, and Speed Determination

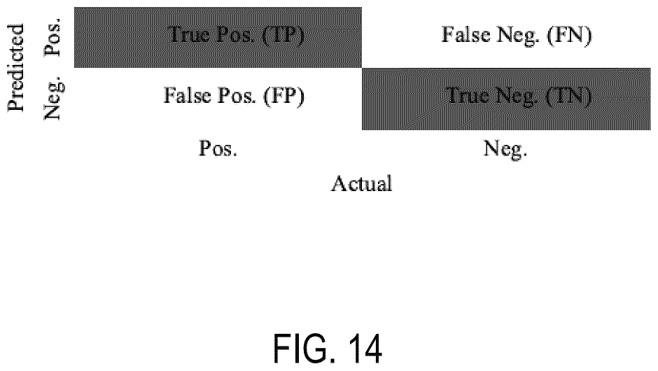

To conduct a thorough assessment of effectiveness of the inventive concepts using the complete dataset encompassing all motors, various metrics such as accuracy, precision, recall, and F1 score may be utilized. The evaluation of these metrics can be based on the information provided in the confusion matrix illustrated in FIG. 14. FIG. 14 illustrates an example confusion matrix for binary classification. Each metric is defined as follows.

Accuracy: The measure of the total number of correct predictions (both positive and negative) made by the model divided by the total number of predictions.

$$Accuracy = \frac{TP + TN}{TP + TN + FP + FN} \qquad ( Equation 5 )$$

Precision: the measure of the model's ability to correctly predict positive instances out of all predicted positives.

$$Precision = \frac{TP}{TP + FP} \qquad ( Equation 6 )$$

Recall: Indicates the model's proficiency in correctly detecting positive instances.

$$Recall = \frac{TP}{TP + FN} \qquad ( Equation 7 )$$

F1 score: Harmonic mean of precision and recall, providing a balanced view of model performance.

$$F 1 score = 2 * \frac{Recall \times Precision}{Recall + Precision} \qquad ( Equation 8 )$$

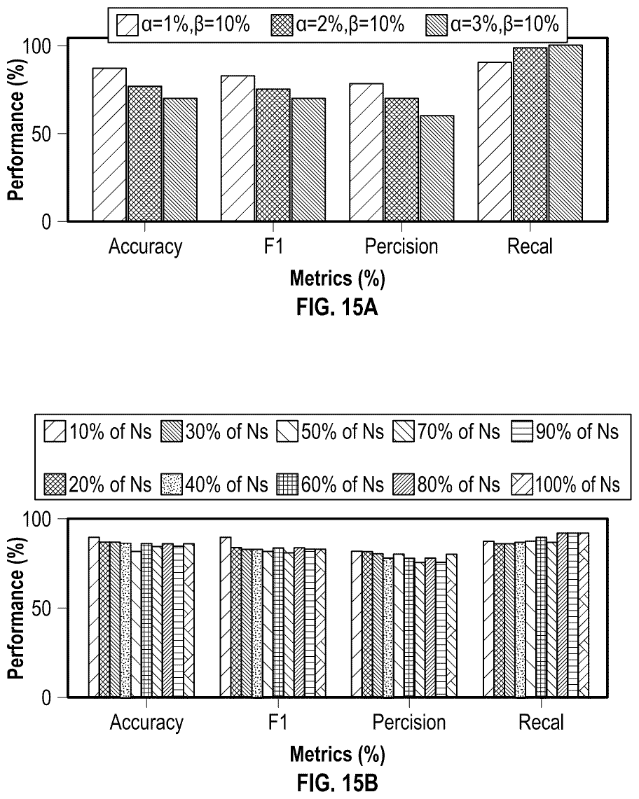

FIGS. 15A and 15B illustrate an example evaluation of classification metrics at various α and β sensitivity levels and operational speeds. FIG. 15A presents the evaluation, encompassing predefined metrics. It is evident that by choosing a lower α value, higher accuracy and F1 score can be achieved. However, this comes at the cost of lower recall when compared to a higher α value. Therefore, the selection of the appropriate α value depends on the desired detection strategy. If minimizing false detections is the priority, then increasing the α value is recommended. Conversely, if the objective is to have a more sensitive fault detection process, albeit with some misdetections, a lower α value should be employed. Moreover, in order to establish the suitable operational parameters for executing the disclosed techniques, the metrics can be furnished for a range of speeds spanning from 10% to 100% of the nominal speeds. FIG. 15B shows that the metric displays a consistent and gradual change as the speed varies. Nonetheless, higher speeds yield only marginal enhancements in the recall value. Consequently, it is feasible to attain a greater recall rate while maintaining an acceptable level of accuracy and F1 score at high speeds.

### ML Comparison

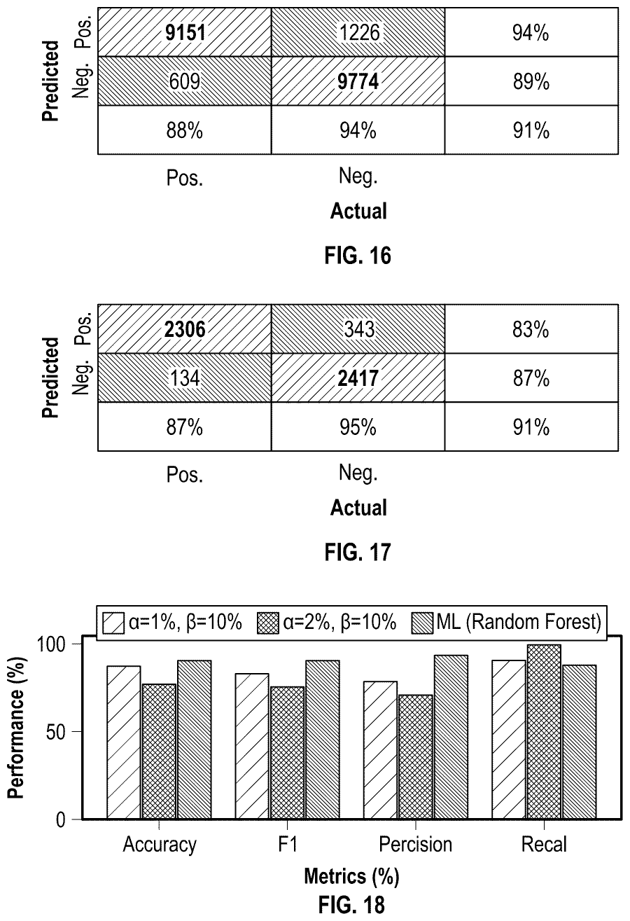

To evaluate the efficacy of the disclosed techniques, a random forest machine learning (ML) model is constructed with the objective of binary classification. With a goal of implementing the trained model on a microcontroller and developing a real-time condition monitoring platform, a trade-off must be made between model size and performance by adjusting the hyperparameter values. To this end, the hyperparameters of the random forest model can be set as follows: the number of estimators is set to 3, and the max depth is set to 5. Moreover, by utilizing a single current phase signal, the recommended features, including RMS, peak, and crest factor, were calculated for each motor. Subsequently, the dataset was split, with 80% allocated for training and the remaining 20% reserved for testing. Detailed confusion matrices for both the training and test sets are presented in FIGS. 16 and 17, respectively. FIG. 16 illustrates an example confusion matrix for a training dataset of the machine learning model, in accordance with some aspects of the inventive concepts. FIG. 17 illustrates an example confusion matrix for a test dataset of the machine learning model, in accordance with some aspects of the inventive concepts. The presence of false detection within the model is apparent, which can be attributed to the inherent limitations in adjusting hyperparameters. Additionally, it is important to note that the trained model being utilized is not considered optimal, as its primary function is solely for comparative purposes. FIG. 18 visually depicts the comparative evaluation of the disclosed techniques using two α sensitivity levels alongside the developed machine learning (ML) model employing the introduced metrics. The ML model demonstrates superior accuracy and F1 score in contrast to the disclosed techniques. However, it is noteworthy that the disclosed techniques with α=2% exhibits superior recall and precision. Hence, the disclosed techniques showcase commendable performance when compared to the trained model.

### Micro Controller Implementation

To assess and compare the complexity of the disclosed techniques and the ML random forest model, TI F280049 MCU is employed. Both the disclosed techniques and the ML model were loaded onto the MCU for evaluation. The routine's execution was measured in terms of the number of MCU instruction cycles and memory used, which is presented in Table 2. Considering a total of 10,000 available instruction cycles with an ISR rate of 10 kHz and a CPU speed of 100 MHz, the disclosed techniques required 250 instruction cycles and utilized 172 units of memory. On the other hand, the ML random forest model necessitated 1,000 instruction cycles and 364 units of memory.

TABLE 2
ML MODEL VS DISCLOSED ROUTINE ON TI F280049

| Model | Instruction cycle | Memory (Kb) |
|---|---|---|
| ML (Random Forest) | 1000 | 364 |
| Routine | 250 | 172 |

### CONCLUSION

Disclosed herein are techniques for a real-time, distributed bearing fault detection based on analysis of one or more electrical parameters such as, but not limited to, current. In some cases, the techniques apply particularly to small cooling fan motors, though in other cases, the techniques may be applicable to larger motors as well. The techniques can be compatible with low-end controllers. Some advantages include minimal computational requirements and memory usage. The disclosed techniques employs simple time domain features, including RMS, peak, and crest factor, to identify distributed bearing faults arising from both lubrication issues and contamination problems. The findings stemming from a comprehensive examination of seven distinct experimental configurations involving motors of different sizes and subjected to diverse loading scenarios reveal that the disclosed techniques delivers remarkable results. It attains accuracy levels exceeding 92%, while consistently maintaining an F1 score exceeding 90%. These consistent achievements firmly establish the disclosed techniques as a robust and effective solution for the accurate and timely identification of distributed bearing faults in compact cooling fan motors. Moreover, the routine's sensitivity can be fine-tuned through parameter adjustments, enabling optimized and dependable fault detection. When compared to a machine learning random forest model, the disclosed techniques displays promising accuracy and recall metrics. Notably, in terms of implementation on microcontrollers, the disclosed techniques presents a more streamlined and efficient solution than the machine learning model. It demands fewer instruction cycles and requires less memory to facilitate real-time operations. In summary, the disclosed techniques showcase its proficiency in accurately detecting bearing faults while offering the additional benefit of implementation efficiency. Future research could involve further refining the disclosed techniques and exploring its applicability in other motor fault detection scenarios.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may include, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method for dynamically detecting faults in motor bearings, the method comprising:
obtaining operational data corresponding to the operation of a motor, wherein the operational data comprises an electrical parameter indicative of an electromotive functionality of the motor;
retrieving a baseline performance metric from a database, wherein the baseline performance metric is derived from historical data corresponding to normal, healthy operation of the motor, the baseline performance metric including a motor current signal;
continuously monitoring the operational data to obtain real-time performance metrics, including a real-time root mean square (RMS) value, a real-time peak value, and a real-time crest factor of the electrical parameter;
performing a trend analysis on the real-time performance metrics to identify deviations from the baseline performance metric;
dynamically determining a first threshold by calculating a short-term statistical variance from the baseline performance metric, wherein the first threshold represents a range of acceptable performance variation, and deviations beyond this range suggest early signs of anomalies in the motor bearings;
dynamically determining a second threshold by calculating a long-term cumulative deviation from the baseline performance metric, wherein the second threshold represents a significant and sustained deviation from normal performance, suggesting anomalies in the motor bearings;
detecting a fault condition in the motor bearings when the real-time performance metrics exceed either the dynamically determined first threshold, indicating early signs of anomalies, or the second threshold, indicating significant anomalies; and
outputting an indication of the fault condition.

2. The method of claim 1, wherein the historical data comprises data corresponding to the operation of the motor during a first period of time.

3. A method for detecting faults in motor bearings, the method comprising:
obtaining operational data corresponding to the operation of a motor, wherein the operational data comprises an electrical parameter indicative of an electromotive functionality of the motor;
analyzing the operational data to extract performance metrics;
determining a fault condition based on the analysis of the operational data; and
outputting an indication of the fault condition.

4. The method of claim 3, further comprising:
dynamically determining a first threshold by calculating short-term statistical variances from a baseline performance metric, where the baseline performance metric is derived from historical data of normal motor operation and the short-term statistical variances are calculated using differences between recent performance metric values and the baseline, wherein the first threshold represents a range of acceptable performance variation, and deviations beyond this range suggest early signs of anomalies in the motor bearings; and
comparing the performance metrics with the first threshold,
wherein the determining a fault condition is based on a determination that the performance metrics deviate from the baseline performance metric by an amount that satisfies the first threshold.

5. The method of claim 4, wherein the first threshold corresponds to deviations of 1% to 4% from the baseline performance metric.

6. The method of claim 3, further comprising:
dynamically determining a second threshold by calculating long-term statistical variances from a baseline performance metric, where the long-term statistical variances are calculated using differences between a long-term trend of performance metric values and the baseline performance metric, wherein the second threshold represents a significant and sustained deviation from normal performance, suggesting anomalies in the motor bearings;
comparing the performance metrics with the second threshold; and
wherein the determining a fault condition is based on a determination that the performance metrics deviate from the baseline performance metric by an amount that satisfies the second threshold.

7. The method of claim 6, wherein the second threshold corresponds to deviations of 3% to 10% from the baseline performance metric.

8. The method of claim 6, further comprising:
comparing the extracted performance metrics to a threshold, wherein the threshold comprises at least one of:
a first threshold indicative of early signs of anomalies, wherein deviations from normal operating conditions that meet or exceed this threshold suggest potential early-stage bearing issues; or
a second threshold indicative of significant deviations from normal operating conditions, wherein deviations that meet or exceed this threshold suggest advanced bearing faults,
wherein the determining the fault condition is based on the comparing.

9. The method of claim 3, wherein the performance metrics comprise at least two of a root mean square (RMS) value, a peak value, or a crest factor of the electrical parameter.

10. The method of claim 3, further comprising comparing the extracted performance metrics to predetermined thresholds, wherein the predetermined thresholds are based on historical data correlated with known bearing faults under varying operational conditions, wherein determining the fault condition comprises identifying at least one instance where a performance metric satisfies a predetermined threshold.

11. The method of claim 3, wherein the electrical parameter comprises at least one of an electric current flowing through windings of the motor, a voltage measured across terminals of the motor, or a power consumption by the motor.

12. The method of claim 3, further comprising:
performing trend analysis on the operational data and extracted performance metrics to identify changes in motor bearing conditions over time, wherein the trend analysis comprises statistical analysis of the data to detect patterns indicative of bearing wear or degradation; and
outputting an indication of a maintenance action, wherein the indication is indicative of at least one of a predictive maintenance schedule or a recommendation for motor bearing replacement or repair.

13. The method of claim 3, wherein determining the fault condition comprises recognizing patterns in the performance metrics indicative of a bearing fault, wherein the patterns reflect characteristic anomalies associated with bearing faults identified from historical operational data.

14. The method of claim 3, wherein outputting the indication of the fault condition comprises at least one of:
generating an alarm signal indicating a presence of the fault condition in the motor bearings;
logging an alarm event with a timestamp, the associated performance metrics, and the fault condition in a database for historical tracking and/or analysis; or
transmitting a notification to a remote monitoring system, the notification comprising details of the fault condition, the associated performance metrics, and the timestamp.

15. The method of claim 3, wherein the performance metrics comprise a root mean square (RMS) value and/or a peak value, wherein changes in the RMS value and/or the peak value are indicative of at least one of increased friction or reduced lubrication effectiveness, and wherein the bearing fault is defined as a condition characterized by improper lubrication.

16. The method of claim 3, wherein the performance metrics comprise a crest factor, wherein fluctuations in the crest factor reflect intermittent obstruction or irregularities in the bearing surfaces, and wherein the bearing fault is defined as a condition characterized by contamination with debris.

17. The method of claim 3, wherein the performance metrics comprise noise in the electrical parameter, wherein increased noise in the electrical parameter is indicative of surface degradation or roughness, and wherein the bearing fault is defined as a condition characterized by wear of the bearing surfaces.

18. The method of claim 3, wherein the performance metrics comprise at least one of a root mean square (RMS) value, a peak value, or a crest factor, wherein variations in the at least two of the RMS value, the peak value, or the crest factor indicate a loss of proper bearing alignment or spacing, and wherein the bearing fault is defined as a condition characterized by increased clearance within the bearing.

19. The method of claim 3, further comprising applying a trained machine learning algorithm to the extracted performance metrics to classify the fault condition.

20. A method for real-time detection of bearing faults in small cooling fan motors, comprising:
monitoring a current signal of a motor to collect operational data;
analyzing the operational data to compute time-domain statistical features, the time-domain statistical features comprises root mean square (RMS) values, peak values, and crest factors;
comparing the time-domain statistical features against baseline values established from healthy motor operation;
identifying deviations in the time-domain statistical features that indicate a presence of a bearing fault; and
generating an alert when the deviations exceed predefined threshold levels, the alert corresponding to an indication of bearing faults.
